(19) United States
(12) Patent Application Publication
(10) Pub. No.: US 2019/0331929 A1
(43) Pub. Date: Oct. 31, 2019

(54) LASER BROADBAND CLADDING DEVICE

(71) Applicant: SOOCHOW UNIVERSITY, Suzhou (CN)

(72) Inventors: Tuo SHI, Suzhou (CN); Shihong SHI, Suzhou (CN); Jianjun SHI, Suzhou (CN); Geyan FU, Suzhou (CN)

(21) Appl. No.: 16/319,379

(22) PCT Filed: Dec. 28, 2016
(86) PCT No.: PCT/CN2016/112644

§ 371 Date: Jan. 21, 2019

(30) Foreign Application Priority Data
Oct. 9, 2016 (CN) 201610879013.X

(51) Int. Cl. G02B 27/14; G02B 27/09; B23K 26/144; B23K 26/60

(52) U.S. Cl. CPC G02B 27/14; G02B 27/0977; C23C 24/08; B23K 26/60; B23K 26/144

(57) ABSTRACT

The present invention relates to the broadband laser cladding apparatus and more particularly to the field of 3D forming. The broadband laser cladding apparatus includes a mirror assembly and a multifunctional reflective optics assembly. The mirror assembly is configured to transmit the laser from the laser generator to the multifunctional reflective optics assembly. The multifunctional reflective optics assembly comprises an upper focusing mirror assembly to receive and redirect the laser to form the cladding spot on the work piece, as well as a reflective mirror assembly to receive and redirect the laser to form the pre-heating and slow-cooling spots outside the cladding spot, wherein the reflective mirror assembly is adjoining with the bottom edge of the upper focusing mirror assembly.

### CLAIM OF PRIORITY

The present application claims priority from Chinese patent application CN 201610879013.X filed on Oct. 9, 2016, the content of which is hereby incorporated by reference into this application.

### TECHNICAL FIELD

The present invention relates to a broadband laser cladding apparatus and more particularly to the field of 3D forming.

### BACKGROUND

The technology of the three-dimensional laser cladding deposition for metal and alloy components, cladding strengthening modification, renovation and remanufacture for the important functional surfaces, that has been widely used in the fields of aerospace, national defense, shipbuilding, mining, metallurgy, machinery manufacture, etc, also, regarded as the main development direction of the current developed countries. Belonging to the above technology, broadband laser cladding is an efficient manufacturing technology through deposition. Compared with the single deposition width of 1-5 mm from the narrowband laser cladding, the broadband laser cladding with the single deposition width of 10-40 mm increases the cladding rate dramatically. Meanwhile, it can also push down the times of welding and repeated heating, so as to improve the quality of cladding layer. The traditional large-scale parts manufacturing relying on large-scale die-forging or die-casting machines, which results in the following disadvantages: high cost, long periods, much limitation and uncontrollable defects. However, the broadband laser cladding is a processing method with a discrete and layer-by-layer randomly formed stacking process that can save large-scale equipments such as forging presses. The above process and the gradient materials forming method thereof are more conducive to maintain the microstructure properties and reduce the defects, so that they become more advantageous in the manufacturing fields of the large-scale components strengthening, repairing and 3D forming.

The broadband laser cladding method contains several critical technologies: laser beam intensity and shape conversion, broadband powder-feed system, and laser-powder coupling. The current operation method for broadband powder-feed system comprises: the alloy powder beam is fused by the laser irradiation to form a broadband melting belt after being jet onto the broadband laser spot from either or both sides of the rectangular solid laser beam. The powder feeding from both sides can be used for a round-trip scanning, so as to soar up the forming rate. No matter feeding from the single side or both sides, the powder beam is located outside the laser beam. Such a processing method is generally called external broadband powder feeding. Combined with FIG. 1a, it is demonstrable to point out some existing problems in such method: poor capability of laser-powder coupling, low powder utilization, unstable cladding layer quality, and the unsuitability for the forming of complex structure with large spatial inclination, etc.

In order to solve the above mentioned problems, the prior art provides a hollow broadband laser method with dual-beam to feed powders inside the laser beams (FIG. 2). The theories of the light path and the powder feeding process are described as follows: using the semiconductor or fiber laser flat-top light source purchased from the market as the laser generator; bisecting the incident laser beam through the spectroscope; forming the dual-focused hollow laser beams through the reflection of the converging mirrors; feeding the powder beam into the center of the dual-focused laser spots (molten pool) vertically with feeding tubes; completing the laser-powder coupling process. As shown in FIG. 2 and FIG. 1b, the solid laser with a single-beam is converted into the hollow laser with a dual-beam; the dual-beam of powder feeding outside the laser obliquely is switched into the single-beam of powder feeding inside the laser vertically. The positions of the laser beam and the powder beam are reversed to each other, which brings the following advantages:

(1) As shown in FIG. 1b and FIG. 2, the dual-beam of the bisected laser are passing along both sides of the powder beam to envelop it. In its defocus position where the distance between the spots of the dual-beam laser is slightly increased, the molten pool can still be composed at the irradiation zone and the gap of the dual-beam laser, as long as the distance of the gap is under the threshold range; meanwhile the center line of the powder bundle is always vertical to the centre line of the molten pool. The collimating shielding gas curtain surrounding a single powder beam is used for three purposes: collimating the powder beam, protecting the molten pool and the inner cavity of the nozzle chamber. The single powder beam is keeping parallel with the corresponding single gas curtain. Even though there is fluctuation between the nozzle and the processing surface, the laser beam and the powder beam would always be aimed to the center of the molten pool. Thus the amount of the powder feeding into the molten pool is basically unchanged, so is the relative position between the laser beam and the powder beam during the round-trip scanning.

(2) The single broadband powder beam is always between the spots of the dual-beam laser, and one laser beam at the trailing edge of the powder beam is continually to capture the powders into the molten pool during the round-trip scanning. Therefore, the powder diffusion and the surface adhesion are considerably diminished that leads to a higher utilization rate of the powder, more stable amount of powders feeding into the molten pool, a more steady process for melting, and a much more homogeneous melting surface, and less defects as well.

(3) The collimating shielding gas tightly surrounds the powder beam for coaxial feeding, which can form a pressure gas curtain (FIG. 1b) in order to further align and collimate the feeding path of the powder beam, with an aim to make the feeding path accurate, straight, slender and strengthened. The powder-gas flow is always jetting to the molten pool perpendicularly, which is favorable for the pool to keep stable and stationary, even though it is working on the cladding with a large spatial inclination and the dynamic swinging forming.

(4) The dual-reflection converging mirrors provide terrific flexibility for the broadband laser-powder coupling. There are different working planes being designed on the two converging mirrors for different spot sizes and energy distributions to meet the requirement of the light distribution with different functions, as well as the laser-powder coupling, such as the saddle-type light intensity distribution with enhanced energy at both ends, the low energy and density light beam with pre-heating and slow-cooling function.

However, the existing powder feeding method of the dual-beam broadband laser still faces the follow challenges: the quench of the cladding layer will produce extreme overheating and undercooling to the processed materials, which leads to the crack of the cladding layer. Because of that, pre-heating and slow-cooling technology is brought into this field. Such technology can effectively decrease the temperature gradient and release the residual thermal stress while processing. At present, the external heat sources, such as electromagnetic induction and resistance heating, are exploited most to heat the work piece in this technology. Their heating temperature usually ranges from 200° C. to 600° C. Although heating the work piece integrally would be feasible in the processing, it still brings some problems: in the case of repairing or 3D forming for the large piece, the distance from the heating zone will change with the machining point, that results in a variation of the pre-heating and slow-cooling temperature; besides that, adding the external heat sources as an additional device is cumbersome for the whole cladding apparatus.

One method for the above problems is that: the low-density laser beam is used to perform a follow-up processing of local pre-heating and slow-cooling in front of or behind the molten pool. This method gets rid of the add-on heat source. For example, Carl Edward Ericson proposes a concept of using one laser generator to input a slender circular beam with high-density for cladding, and another laser generator to input a larger coaxial circular beam with low density for pre-heating and slow-cooling (US2009/0283501A1). Wang Dongsheng discloses a convex laser spot with the function of pre-heating and slow-cooling, which is composed of two overlapped rectangular spot. Its power density is enhanced in the middle zone, and languished on the edges. The simulation experiment proves that the convex spot declines the temperature gradient of the cladding zone and the non-cladding zone, curtails the thermal stress by 10%, and diminishes the cracking tendency (CN201310286772.1). Ma Guangyi presents a pre-heating and slow-cooling method with an elliptical homogeneous laser beam during the cladding process, i.e., to split the laser into superimposed small rectangular beams for cladding and large elliptical beams for pre-heating and slow-cooling (CN201410480190.1). Zhou Shenfeng and Dai Xiaoqing propose two methods as follows: the first one is to bisect the laser beam into the cladding and pre-heating spots on the processing surface through transition; another one is to bisect the laser beam into the pre-heating and the post-cooling spots, and to exploit another laser generator to provide the cladding spot between the pre-heating and post-cooling spot (CN201110352225, CN20110352257.X).

The optical paths and the principles about the above-mentioned multi-beams composed of main and auxiliary beams for follow-up pre-heating and slow-cooling process have been mostly reported. Some of them use the simulation method to verify the effect, and some employ the pre-coating method to clad. Nevertheless, the optical lens/mirrors assembly containing the main laser beam for cladding and auxiliary laser beam for pre-heating and slow-cooling, or the integrated nozzle device is rarely reported.

### SUMMARY

The object of the present invention is to provide a broadband laser cladding apparatus to meet the requirements of heat treatment processing technology for different materials and structures, and reduce the defects such as the residual thermal stress and the molten layer crack.

In order to achieve the above object, there is provided a broadband laser cladding apparatus for the broadband laser cladding processing through converting and projecting the laser generated by the laser generator onto the work piece, comprising:

a multifunctional reflective optics assembly defining (i) an upper focusing mirror assembly configured to receive and redirect the laser to form the cladding spot on the work piece, (ii) a reflective mirror assembly adjoining with bottom edge of the upper focusing mirror assembly configured to receive and redirect the laser to form the pre-heating and slow-cooling spots outside the cladding spot;

a mirror assembly configured to transmit the laser from the laser generator to the multifunctional reflective optics assembly.

In one embodiment of the present invention, the multifunctional reflective optics assembly is a single reflector with a work zone, and the upper focusing mirror assembly and the reflective mirror assembly are disposed on the work zone.

In one embodiment of the present invention, the multifunctional reflective optics assembly comprises two reflectors, and the upper focusing mirror assembly and the reflective mirror assembly are disposed on each reflector respectively.

In one embodiment of the present invention, a pair of the multifunctional reflective optics assembly is configured wherein the pair of upper focusing mirror assembly is face-to-face disposed with each other, and the other pair of reflective mirror assembly is also face-to-face disposed with each other.

Furthermore, the mirror assembly comprises a beam splitting plane mirror containing the first reflective plane and the second reflective plane, and the two planes are back-to-back arranged with each other to transmit the laser to the corresponding the multifunctional reflective optics assembly that each of them is facing respectively.

Furthermore, the first reflective plane and the second reflective plane are back-to-back arranged from each other symmetrically.

Specifically, the angle between the first reflective plane and the second reflective plane ranges from 60° to 120°.

In one embodiment of the present invention, the broadband laser cladding apparatus further comprises:

a powder supplier containing a plurality of or single powder feeding channels to supply powders, wherein one end of the powder supplier is configured below the mirror assembly and extends to the laser work zone perpendicularly.

In one embodiment of the present invention, the broadband laser cladding apparatus further comprises:

a collimating lens disposed between the laser generator and the mirror assembly to convert the diverging laser beams from the laser generator into parallel laser beams to project to the mirror assembly.

Furthermore, each multifunctional reflective optics assembly can be configured to move toward the laser-emitting direction of the beam splitting plane mirror.

Furthermore, the cladding spot is a broadband focusing linear spot, and the pre-heating and slow-cooling spot is a rectangle light spot.

The beneficial effects of the present invention at least include: to configure the upper focusing mirror assembly to receive and redirect the laser to form the cladding spot on the work piece, and the reflective mirror assembly adjoining with bottom edge of the upper focusing mirror assembly to receive and redirect the laser to form the low-density spots for pre-heating and slow-cooling outside the cladding spot, so as to meet the requirements of heat treatment processing technology for different materials and structures, and reduce the defects such as the residual thermal stress and the molten layer crack.

### BRIEF DESCRIPTION OF THE DRAWINGS

FIG. 1a schematically illustrates an external feeding system outside the single laser beam of the existing technology.

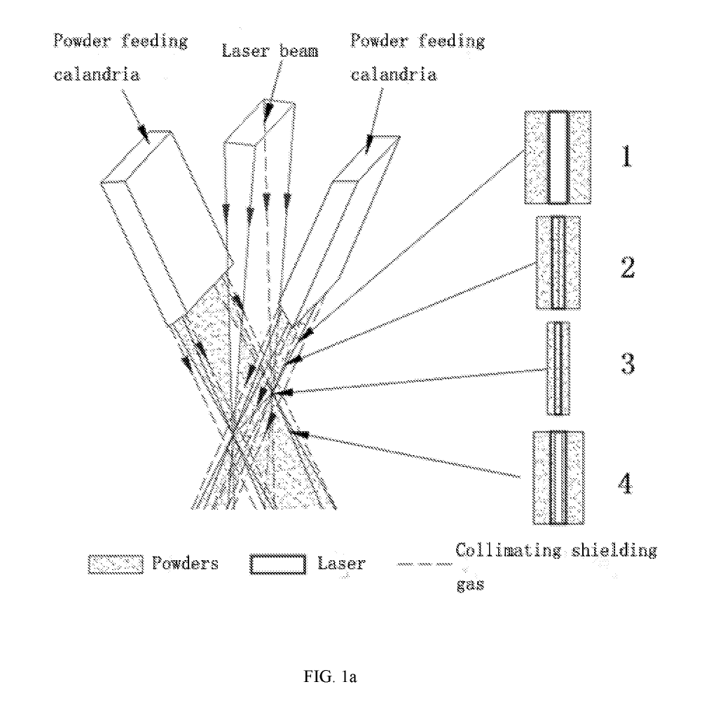

FIG. 1b schematically illustrates an internal feeding system inside the dual laser beam of the existing technology.

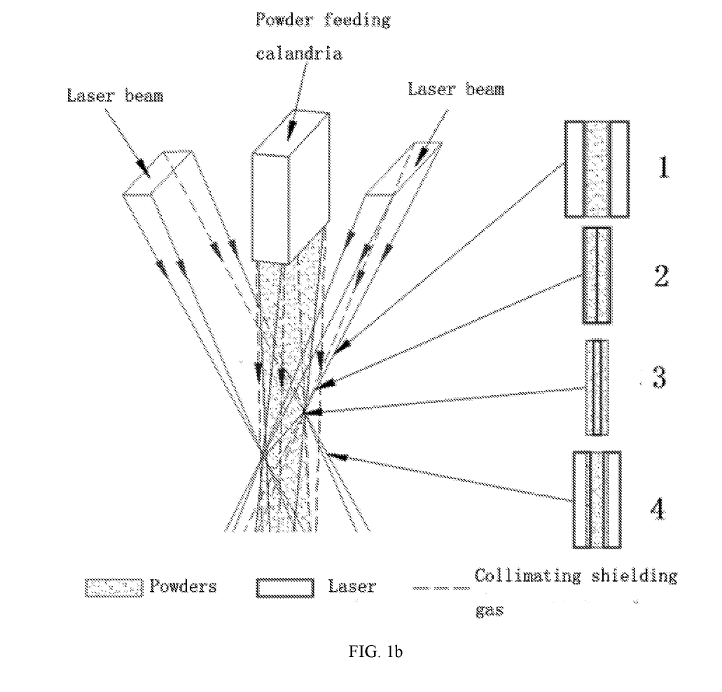

FIG. 2 schematically illustrates an internal feeding system inside the broadband dual laser beam of the existing technology.

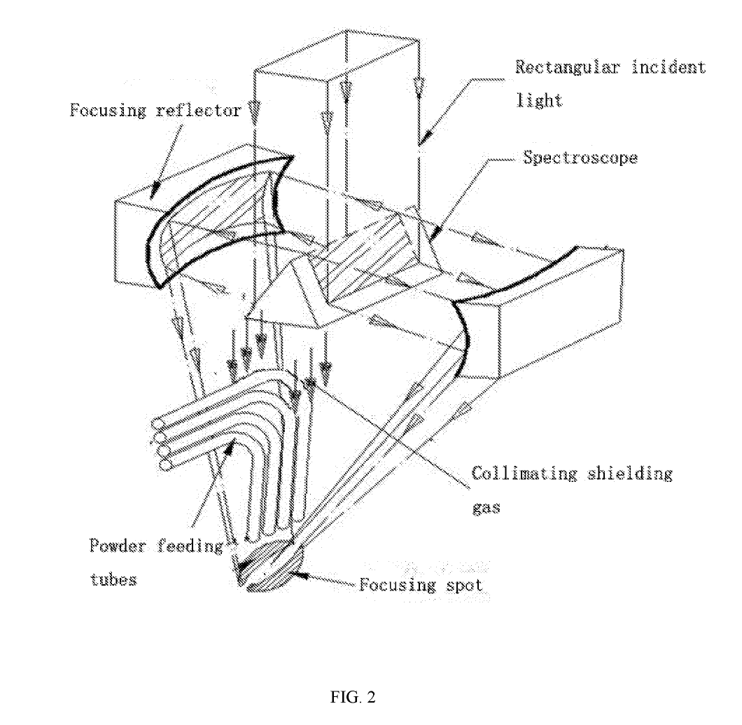

FIG. 3 shows a schematic diagram of a broadband laser cladding apparatus according to some embodiments of the present disclosure, wherein the dotted line demonstrates the projection direction of the laser beam.

### DETAILED DESCRIPTION

A further description of the invention will be made in detail as below with reference to embodiments of the present invention taken in conjunction with the accompanying drawings. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

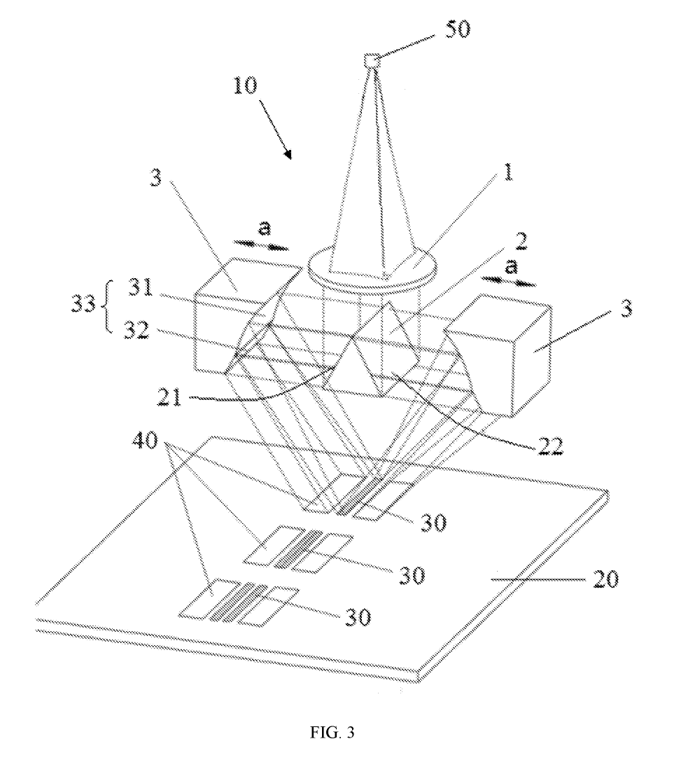

With reference to FIG. 3, FIG. 3 is a structure schematic view of a broadband laser cladding apparatus 10 according to an preferred embodiment of the present disclosure, which is used for the broadband laser cladding processing through converting and projecting the laser generated by the laser generator (not shown in FIG. 3) onto the laser work zone 20. The laser generator has a power of 1000-2000 W, and transmit laser beam through optical fiber 50. The broadband laser cladding apparatus 10 is positioned above the laser work zone 20 and comprises a collimating lens 1, a mirror assembly 2 and a multifunctional reflective optics assembly 3. The collimating lens 1 is particularly selected in accordance with the laser generator power, and disposed between the mirror assembly 2 and the multifunctional reflective optics assembly 3. In this embodiment, the collimating lens 1 is over the mirror assembly 2 which has a reflective plane on each side. A pair of the multifunctional reflective optics assembly is configured to cooperate with the reflective planes on both sides of the mirror assembly 2. The first reflective plane 21 and the second reflective plane 22 are back-to-back arranged from each other symmetrically and inclined upward to face to the corresponding multifunctional reflective optics assembly 3. The multifunctional reflective optics assembly 3 comprises an upper focusing mirror assembly 31 and a reflective mirror assembly 32 adjoining with bottom edge of the upper focusing mirror assembly 31. Herein, the upper focusing mirror assembly 31 can be selected from the concave mirrors, such as a parabolic mirror. Meanwhile a plane mirror can be employed as the reflective mirror assembly 32. The upper focusing mirror assembly 31 is inclined to the laser work zone. The relative angle of the extension lines for the reflective mirror assembly 32 and the laser work zone 20 is an acute angle. The collimating lens 1 is configured to convert the diverging laser beams from the optical fiber 50 into parallel laser beams to project to the mirror assembly 2 which then transmits the laser to the multifunctional reflective optics assembly 3. The upper focusing mirror assembly 31 receive and redirect the laser to form a broadband focusing linear spot 30 (i.e., a high-density cladding spot) on the laser work zone 20; and the reflective mirror assembly 32 receive and redirect the laser to form a rectangle light spot 40 (i.e., a low-density spot for pre-heating and slow-cooling) on the laser work zone 20. The rectangle light spot 40 is always located outside the broadband focusing linear spot 30. In accordance with another embodiment of the present invention, there is also provided a broadband laser cladding apparatus unnecessarily comprising the collimating lens, if the laser is ideal parallel from the laser generator.

According to this embodiment, each multifunctional reflective optics assembly 3 is a single reflector with a work zone 33, and the upper focusing mirror assembly 31 and the reflective mirror assembly 32 are disposed on the work zone 33, i.e., the upper focusing mirror assembly 31 and the reflective mirror assembly 32 constitute the integrated work zone 33. Such design simplifies the overall structure. In accordance with another embodiment of the present invention, each multifunctional reflective optics assembly 3 comprises two reflectors, and the upper focusing mirror assembly 31 and the reflective mirror assembly 32 are disposed on each reflector respectively. The two reflectors can be connected together through fastenings or glues. The upper focusing mirror assembly 31 has a width ratio of 1:1 as well as a height ratio of 8:2˜7:3 with the reflective mirror assembly 32, and a focus length of 150 mm-500 mm, no matter whether it is separately arranged from the reflective mirror assembly 32. Besides that, the pair of the upper focusing mirror assembly 31 are symmetrically arranged on the sides of the centre line for the mirror assembly 2 to form two strips of symmetric broadband focusing linear spots 30 on the focusing plane or the laser work zone 20. The thickness of each linear spot 30 is about 1-3 mm. The pair of reflective mirror assembly 32 are also symmetrically arranged on the sides of the centre line for the mirror assembly 2 to form two symmetric rectangle light spots 40 on the laser work zone 20 that each is 0-3 mm away from the broadband focusing linear spot 30.

According to this embodiment, the mirror assembly 2 comprises a beam splitting plane mirror containing the first reflective plane 21 and the second reflective plane 22, and the two planes are back-to-back arranged with each other to transmit the laser to the corresponding the multifunctional reflective optics assembly that each of them is facing respectively. Such design can further simplify the overall structure of the broadband laser cladding apparatus 10. Specifically, the first reflective plane 21 and the second reflective plane 22 are back-to-back arranged from each other symmetrically. In accordance with another embodiment, there are two sets of the mirror assembly which include the first mirror assembly with the first reflective plane and the second mirror assembly with the second reflective plane. The first mirror assembly and the second mirror assembly are back-to-back arranged from each other, and facing to the corresponding multifunctional reflective optics assembly respectively. No matter whether the mirror assembly 2 is selected from a beam splitting plane mirror or some other types of optics, the angle between the first reflective plane and the second reflective plane is 60°-120°, among which 90° is more favorable. When the angle is 90°, the structure of the mirror assembly is simpler and easier to manufacture.

In order to adjust the positions of the broadband focusing linear spot 30 and the rectangle light spot 40 to meet different process requirements, the multifunctional reflective optics assembly 3 is configured to move toward the beam splitting plane mirror 2 relatively, i.e., the relative spacing of the two multifunctional reflective optics assembly 3 is adjustable, so that the two strips of broadband focusing linear spots 30 on the laser work zone 20 can be separated (with a certain spacing) or overlap, and the separated spacing or the overlapped extent can be controlled (the defocus amount of the focusing laser beam and the thickness of the linear spot can be invariable). Herein, when the angle between the first reflective plane 21 and the second reflective plane 22 is 90°, the two reversed laser beams are reflected along the horizontal direction, and the pair of multifunctional reflective optics assembly 3 is configured to move along the laser reflection direction of the beam splitting plane mirror 2 (The direction indicated by the arrow a in FIG. 3 is the moving direction of the multifunctional reflective optics assembly 3 in the present embodiment, that is, the horizontal direction, which is also the reflection direction of the laser beam of the beam splitting plane mirror 2). In accordance with anther embodiment, when the angle between the first reflective plane 21 and the second reflective plane 22 is not 90°, the pair of multifunctional reflective optics assembly 3 can still move along the light-emitting direction of the laser beam of the beam splitting plane mirror 2.

The broadband laser cladding apparatus further comprises a powder supplier (not shown in FIG. 3) with an end disposed below the mirror assembly 2. Specifically, the powder supplier is located under the mirror assembly 2. The end of the powder supplier disposed under the mirror assembly 2 further extends perpendicularly to the laser work zone 20 which is below the mirror assembly 2, that is, the powder supplier is located between the two laser beams reflected from the upper focusing mirror assembly 31, and its export (nozzle) is aimed at the center of the two broadband focusing linear spots 30, with a spacing of 10-40 mm from the laser work zone 20. By such design, an internal feeding system inside the broadband laser beam can be achieved. The width of the broadband cladding is determined by the length of the broadband focusing linear spot. The powder supplier contains a plurality of or single powder feeding channels. Herein, 3-7 powder feeding channels can be employed to form an array to supply powders, according to different cladding widths. These channels are abreast, and arranged in parallel with the broadband focusing linear spot. A plurality collimating gas channels configured around are parallel and coaxial to the powder feeding channels. The principle for the internal feeding system inside the broadband laser beam is described as follows: the powder supplier is configured below the mirror assembly 2, and enters from the middle cavity of the two multifunctional reflective optics assembly 3, then extends downward, so as to vertically jet the linear powder beam to the center of the broadband focusing linear spot on the laser work zone 20. Around the powder feeding channels there are a plurality collimating gas channels parallel and coaxial to the powder feeding channels and in operation the collimating gas is surrounding the powder beam to jet coaxially to the center of the broadband focusing linear spot on the laser work zone 20. So that the cladding process for the internal feeding system inside the broadband dual laser beam on a horizontal base surface or an inclined base surface with a large angle is accomplished.

The principle of the broadband laser cladding apparatus 10 in the present invention is described as follows: the laser beams from the laser generator are transmitted to the collimating lens 1 by optical fiber 50 possessing a square-section core, and collimated into parallel square laser beam, then the parallel laser beam is converged to the beam splitting plane mirror 2 to bisect into two rectangular laser beams, after that the two rectangular laser beams are respectively reflected to the pair of the multifunctional reflective optics assembly 3 positioned on both sides of the beam splitting plane mirror 2. The pair of multifunctional reflective optics assembly 3 is configured in the broadband laser cladding apparatus 10, and each comprises an upper focusing mirror assembly 31 and a reflective mirror assembly 32. The pair of upper focusing mirror assembly 31 receive and redirect the laser to form two strips of broadband focusing linear spots 30 (i.e., two high-density cladding spots) on the laser work zone 20; and the pair of reflective mirror assembly 32 receive and redirect the laser to form a pair of rectangle light spots 40 (i.e., two low-density spots for pre-heating and slow-cooling) on the laser work zone 20. In operation, the relative spacing between each multifunctional reflective optics assembly 3 and the mirror assembly 2 is adjustable, so that the two strips of broadband focusing linear spots 30 on the laser work zone 20 can be separated (with a certain spacing) or overlap, and the separated spacing or the overlapped extent can be controlled (the defocus amount of the focusing laser beam and the thickness of the linear spot can be invariable).

In conclusion, the broadband laser cladding apparatus 10 can form the broadband focusing linear spots 30 (i.e., the high-density cladding spots) and the rectangle light spots 40 (i.e., the low-density spots for pre-heating and slow-cooling) through the upper focusing mirror assembly 31 and the reflective mirror assembly 32 of the multifunctional reflective optics assembly 3, so as to increase the powder utilization rate, reducing the thermal stress and crack probability of the molten layer, and improve the quality of the broadband cladding.

The pair of multifunctional reflective optics assembly 3 is configured to move toward the beam splitting plane mirror 2, more specifically, each of them is configured to move along the laser-emitting direction of the beam splitting plane mirror 2, so that the width of the molten pool can be adjusted by the separated spacing or the overlapped extent of the corresponding broadband focusing linear spots, that is, the power density variation of the molten pool is controllable. Meanwhile, the movable follow-up zone backward or forward the molten pool for pre-heating and slow-cooling on the laser work zone 20 is formed to further curtail the thermal stress and crack probability.

In addition, the broadband laser cladding apparatus 10 of the present invention has a much simpler and compacter structure than the existing technology, that can synchronously produce two strips of high-density cladding spots and two strips of low-density spots for pre-heating and slow-cooling. The powder feeding channels are configured below the mirror assembly 2. More specifically, the powder feeding channels are located between the two beams of laser reflected from the upper focusing mirror assembly 31, with a nozzle aiming at the center of the two broadband focusing linear spots 30. Thus, the laser beams reflected from the upper focusing mirror assembly 31 are constantly surrounding the powder beam to achieve an accurate powder-laser coupling, no matter whether the single powder bunch ejected by each powder feeding channel is on the focusing position or the defocusing position. The powder beam is always between the two focusing laser beams for the vertical feeding. Such design can defense the defocus fluctuation; increase the input laser ratio, dramatically multiply the powder utilization ratio, reduce the powder adherence to save energy and materials, and improve the cladding quality. The present embodiment employs a plurality of powder feeding channels to diminish the divergence angle and reduce the sectional variation, so as to stabilize the molten channel size and improve the cladding quality.

Moreover, around the powder feeding channels there are a plurality collimating gas channels parallel and coaxial to the powder feeding channels, with an aim to make the feeding path much more accurate, straight, slender, strengthened and controllable. Such design is especially favorable for the nozzle to do the dynamic motion operation possessing postures and angles variation to achieve the multi-directional strengthening repair for the large and complex parts, or 3D additive manufacturing.

It should be understood that, although the description is described in terms of embodiments, the embodiments are not intended to be limited to a single technical solution, and the description of the specification is merely for the sake of clarity. And those skilled in the art should regard the specification as a whole. The technical solutions in the embodiments may also be combined as appropriate to form other embodiments that can be understood by those skilled in the art.

The foregoing detailed descriptions are merely specific illustrations of possible embodiments of the present invention. They are not intended to limit the scope of protection of the present invention. Equivalent modifications, additions and other alternative embodiments without departing from the true scope and spirit of the invention are intended to be included in the scope of the present invention.

1. A broadband laser cladding apparatus for the broadband laser cladding processing through converting and projecting the laser generated by the laser generator onto the work piece, comprising:
a multifunctional reflective optics assembly defining (i) an upper focusing mirror assembly configured to receive and redirect the laser to form the cladding spot on the work piece, (ii) a reflective mirror assembly adjoining with bottom edge of the upper focusing mirror assembly to receive and redirect the laser to form the pre-heating and slow-cooling spots outside the cladding spot;
a mirror assembly configured to transmit the laser from the laser generator to the multifunctional reflective optics assembly.

2. The broadband laser cladding apparatus of claim 1, wherein the multifunctional reflective optics assembly is a single reflector with a work zone, and the upper focusing mirror assembly and the reflective mirror assembly are disposed on the work zone.

3. The broadband laser cladding apparatus of claim 1, wherein the multifunctional reflective optics assembly comprises two reflectors, and the upper focusing mirror assembly and the reflective mirror assembly are disposed on each reflector respectively.

4. The broadband laser cladding apparatus of claim 1, wherein a pair of the multifunctional reflective optics assembly is configured wherein the pair of upper focusing mirror assembly is face-to-face disposed with each other, and the other pair of reflective mirror assembly is also face-to-face disposed with each other.

5. The broadband laser cladding apparatus of claim 4, wherein the mirror assembly comprises a beam splitting plane mirror containing the first reflective plane and the second reflective plane, and the two planes are back-to-back arranged with each other to transmit the laser to the corresponding the multifunctional reflective optics assembly that each of them is facing respectively.

6. The broadband laser cladding apparatus of claim 5, wherein the first reflective plane and the second reflective plane are back-to-back arranged from each other symmetrically.

7. The broadband laser cladding apparatus of claim 5, wherein the angle between the first reflective plane and the second reflective plane ranges from 60° to 120°.

8. The broadband laser cladding apparatus of claim 1 further comprises: a powder supplier containing a plurality of or single powder feeding channels to supply powders, wherein one end of the powder supplier is configured below the mirror assembly and extends to the laser work zone perpendicularly.

9. The broadband laser cladding apparatus of claim 1 further comprises:
a collimating lens disposed between the laser generator and the mirror assembly to convert the diverging laser beams from the laser generator into parallel laser beams to project to the mirror assembly.

10. The broadband laser cladding apparatus of claims 1, wherein each multifunctional reflective optics assembly can be configured to move toward the laser-emitting direction of the beam splitting plane mirror.

11. The broadband laser cladding apparatus of claim 1, wherein the cladding spot is a broadband focusing linear spot, and the pre-heating and slow-cooling spot is a rectangle light spot.
